(19) United States
(12) Patent Application Publication
(10) Pub. No.: US 2024/0139837 A1
(43) Pub. Date: May 2, 2024

(54) CUTTING TOOL

(71) Applicant: GUSTAV KLAUKE GMBH, Remscheid (DE)

(72) Inventors: Egbert Frenken, Heinsberg (DE); Andreas Lehr, Neuss (DE)

(21) Appl. No.: 18/548,488

(22) PCT Filed: Mar. 7, 2022
(86) PCT No.: PCT/EP2022/055757

§ 371 Date: Aug. 30, 2023

(30) Foreign Application Priority Data
Mar. 5, 2021 (DE) 10 2021 105 427.3

(51) Int. Cl. B23D 35/00

(52) U.S. Cl. CPC B23D 35/002; B23D 35/001; B23D 29/002

(57) ABSTRACT

A cutting tool with blade parts having an application surface for a driving force, which essentially extends orthogonal to a cutting plane, is provided. A cutting force acting upon the blade parts causes a counterforce. A line of action of the cutting force extends differently from a line of action of the counterforce. Each application surface has an end facing the cutting plane and an end facing away from the cutting plane. The ends are located on the same side of the cutting plane. In order to reduce a cutting gap between blade edges, the end facing the cutting plane defines a first distance and that the first distance and/or a second distance are chosen such that an intersecting point lies in front of a line of action of the cutting force referred to a clockwise direction.

### TECHNICAL FIELD

The invention pertains to a cutting tool with a tool body having two cutting jaws that can be displaced relative to one another, wherein a first cutting jaw has a first mounting plane, on which a first blade part with a first blade edge is supported, wherein a second cutting jaw has a second mounting plane, on which a second blade part with a second blade edge is supported, wherein a cutting plane, along which the blade parts can be moved, essentially lies parallel to the first and the second mounting plane, wherein the blade edge of the respective blade part or the respective blade part as a whole is pivotable transverse to the associated mounting plane, wherein the blade part has an application surface for a driving force, which essentially extends orthogonal to the cutting plane, wherein mounting contact regions are formed in the mounting planes and a counterholding force acts upon a counterholding surface of the blade part or the blade edge, which is supported on the mounting plane, in said mounting contact regions on a side of the blade part or the blade edge facing away from the cutting plane, wherein a resultant force corresponding to the driving force furthermore forms a first line of force and a resultant force corresponding to the counterholding force forms a second line of force, wherein the first line of force and the second line of force intersect in an intersecting point in a cross-sectional plane, in which the cutting plane is illustrated in the form of a line, wherein the application surfaces are formed with a first distance orthogonal to the cutting plane and the counterholding surfaces are formed with a second distance from the respective application surface in the direction of the cutting plane, wherein a cutting force acting upon the blade parts during a cutting process furthermore causes a counterforce of a workpiece to be cut, wherein a line of action of the cutting force extends differently from a line of action of the counterforce, wherein each application surface has an end facing the cutting plane and an end facing away from the cutting plane, and wherein the ends of each application surface are located on the same side of the cutting plane.

### PRIOR ART

Cutting tools of this type are sufficiently known from the prior art. They may be realized in the form of hand-operated cutting tools or in the form of cutting tools that are installed, in particular, in industrial cutting systems. The cutting force required for cutting a workpiece can be generated with the aid of an electric motor, a hydraulic pump or a compressor. The cutting tools have two blade edges that can be displaced relative to one another, wherein at least one or also both blade edges can be displaced relative to the tool body of the cutting tool. In this case, the aim is to keep a cutting gap being formed between the blade edges as small as possible such that partial regions of the workpiece cannot become jammed in the cutting gap, namely also when a load is exerted by the workpiece. This is particularly problematic, for example, when cutting finely stranded cables, individual strands of which may end up in the cutting gap. In addition, the direction of the cutting force, i.e. the line of action of the cutting force, is inclined relative to the cutting plane, i.e. the cutting direction, in dependence on the cutting geometry of the blade parts such that the blade parts are in turn pressed apart from one another transverse to the cutting plane when the tool is acted upon with a cutting force and the cutting gap is increased, particularly when cutting finely stranded cables in practical applications.

In order to respectively prevent the cutting gap from forming or increasing and to thereby also prevent parts of the workpiece from jamming in the cutting gap, it is known from the prior art to design cutting tools with permanently installed blade parts, in which the cutting gap practically can be adjusted to zero. This is frequently impossible in cutting tools with exchangeable blade parts or cutting jaws, e.g. also in universal tools of the type disclosed in U.S. Pat. No. 6,230,542 B1), DE 199 26 481 A1, which can accommodate different attachments for cutting, crimping and the like.

In order to eliminate a cutting gap being formed between the blade parts, the prior art according to publication US 2020/0055130 A1 furthermore discloses a cutting tool, in which the blade parts are mounted on the cutting jaws in the cutting plane such that the mounting planes of the cutting jaws, as well as the cutting planes of the blade parts, lie on top of one another. As a result of this design, the blade parts are pressed against one another during a cut and the cutting gap is reduced to zero due to a self-adjustment of the cutting tool.

### SUMMARY OF THE INVENTION

Based on the above-described prior art, the invention aims to design an alternative cutting tool that is also suitable, for example, for cutting very finely stranded cables.

In order to attain this objective, it is proposed that the end facing the cutting plane defines the first distance and that the first distance and/or the second distance are chosen in such a way that the intersecting point lies in front of the line of action of the cutting force (F_{Schn}) referred to a clockwise direction.

According to the invention, the blade edge or the blade part is now supported on the cutting jaw in a minimally movable manner relative to the cutting jaw (or alternatively the blade edge relative to an immovable partial region of the blade part) such that the reaction force retroacting upon the blade part from a workpiece does not lie on the line of action of the cutting force. Consequently, an angular deviation is achieved between the direction of the cutting force and the direction of the counterforce retroacting upon the blade part from the workpiece such that a torque is generated, wherein said torque tilts the two blade parts toward one another and thereby closes a potentially formed cutting gap. In order to effectively cut a workpiece, the line of action of the cutting force is not oriented parallel to the cutting plane, but rather tilted relative thereto. The angle between the cutting plane and the line of action of the cutting force usually is greater than 1° and smaller than 30° and preferably lies in a range between 10° and 25°. In this context, the counterforce refers to the force that retroacts upon the blade part from the workpiece when this blade part exerts a cutting force upon the workpiece.

It is proposed that the blade edge is pivotable to such an extent that a cutting gap formed between the blade parts while cutting the workpiece is at least reduced. The pivoting movement of the blade edge corresponds to a slight tilting movement relative to the mounting plane of the associated cutting jaw, wherein the extent of said pivoting movement lies on the order of 1° or fractions thereof. The blade edge particularly can tilt by one or more tenths of a degree. However, the cutting tool particularly may be designed in such a way that the cutting gap is closed by the pivoted blade edge in that the first blade edge of the first blade part contacts the second blade edge of the second blade part. However, at least a partial region of the cutting gap extending in parallel between the cutting planes is closed. This prevents very small partial regions of the workpiece to be cut, e.g. individual strands of a cable, from becoming jammed in the cutting gap.

The above-defined objective furthermore is attained by means of a cutting tool with a tool body having two cutting jaws that can be displaced relative to one another, wherein a first cutting jaw has a first mounting plane, on which a first blade part with a first blade edge is supported, wherein a second cutting jaw has a second mounting plane, on which a second blade part with a second blade edge is supported, wherein a cutting plane, along which the blade parts can be moved, essentially lies parallel to the first and the second mounting plane, wherein the blade edge of the respective blade part or the respective blade part as a whole is pivotable transverse to the associated mounting plane, wherein the blade part has an application surface for a driving force, which essentially extends orthogonal to the cutting plane, wherein mounting contact regions are formed in the mounting planes and a counterholding force acts upon a counterholding surface of the blade part or the blade edge, which is supported on the mounting plane, in said mounting contact regions on a side of the blade part or the blade edge facing away from the cutting plane, wherein a resultant force corresponding to the driving force furthermore forms a first line of force and a resultant force corresponding to the counterholding force forms a second line of force, wherein the first line of force and the second line of force intersect in an intersecting point in a cross-sectional plane, in which the cutting plane is illustrated in the form of a line, wherein the application surfaces are formed with a first distance orthogonal to the cutting plane and the counterholding surfaces are formed with a second distance from the respective application surface in the direction of the cutting plane, wherein a cutting force acting upon the blade parts during a cutting process furthermore causes a counterforce of a workpiece to be cut, wherein a line of action of the cutting force extends differently from a line of action of the counterforce, wherein each application surface has an end facing the cutting plane and an end facing away from the cutting plane, wherein the ends of each application surface are located on the same side of the cutting plane, wherein the end facing the cutting plane defines the first distance, wherein the first distance corresponds to one-tenth or more of an orthogonal distance between the mounting planes or the second distance corresponds to one-tenth or more of an orthogonal distance between the mounting planes or the first distance, as well as the second distance, corresponds to one-tenth or more of an orthogonal distance between the mounting planes, and wherein the intersecting point lies in front of a line of action of a cutting force, which acts upon the blade parts during a cutting process for cutting a workpiece, referred to a clockwise direction.

According to the invention, the cutting tool is designed in such a way that an intersecting point between a direction of a driving force, which acts upon an application surface of the blade part and serves for actuating the cutting tool, and a direction of a counterholding force of the cutting jaw, which acts upon a counterholding surface of the blade part essentially orthogonal to the mounting plane, lies in front of the line of action of the cutting force of the cutting tool—referred to the clockwise direction. As a result of this design, a torque acting upon the blade part is generated and said torque moves the pivotably supported blade part toward the cutting plane. The cutting gap is thereby reduced or completely closed in the above-described manner. The intersecting point between the direction of the driving force and the direction of the counterholding force defines the point, about which the blade part is able to tilt. Since the intersecting point now is, according to the invention, located in front of the line of action of the cutting force referred to the clockwise direction, the blade part tilts inward, i.e. toward the other blade part.

According to a first design variation of the cutting tool, it would furthermore be possible to pivotably support the blade part on the associated cutting jaw. Alternatively, a first partial region of the blade part with a blade edge may be pivotably supported on a second partial region of the blade part, which is immovably connected to the cutting jaw. According to yet another design variation, the cutting jaw carrying the blade part may be pivotably supported on the tool body of the cutting tool. The blade edge can be pivoted relative to the tool body of the cutting tool in all design variations such that the inventive effect for closing the cutting gap can be achieved. The concrete design of the cutting tool, particularly the location at which the pivotability for the blade edge is implemented, depends on the type of the respective cutting tool. In cutting tools with exchangeable blade parts such as universal tools, it is advantageous to support the blade parts on the cutting jaws in a minimally pivotable manner. In cutting tools with blade parts that are immovably fastened on the cutting jaws, it may in contrast be advantageous to pivotably support a partial region of the blade part carrying the blade edge on a stationary partial region of the blade part. The cutting jaw itself may ultimately also be designed so as to be pivotable on the tool body of the cutting tool.

According to a first embodiment, the blade part may be designed in such a way that the counterholding surface of the blade part, which is acted upon with the counterholding force, and the application surface of the blade part, which is acted upon with the driving force, are outwardly spaced apart from the cutting plane by such a distance that their intersecting point lies outside the line of action of the cutting force of the blade part acting upon the workpiece to be cut. This design can be achieved in that the counterholding surface, by means of which the blade part is supported on the mounting plane of the cutting jaw, is spaced apart from the cutting plane farther than in an embodiment according to the prior art, in which the intersecting point between the counterholding force and the driving force lies on the line of action of the cutting force. A contact surface between the counterholding surface of the blade part and the associated cutting jaw may be formed, for example, on a projection of the blade part that protrudes from an outer side of the blade part facing away from the cutting plane. In contrast to the remaining partial regions of the blade part, this projection protrudes into the mounting plane of the cutting jaw. The driving force of the cutting tool causing the displacement of the blade part also acts against an application surface of this projection such that the intersecting point between counterholding force and driving force is shifted outward, i.e. away from the cutting plane, relative to the line of action of the cutting force of the blade part. This results in a pivoting movement of the blade part in the direction of the cutting plane, namely such that the blade edge of the blade part runs ahead. The cutting gap is thereby respectively minimized or closed.

According to an alternative embodiment, the counterholding surface of the first blade part, which is acted upon with the counterholding force, may with respect to a direction extending parallel to the mounting plane be offset relative to the application surface of the first blade part, which is acted upon with the driving force, in the direction of the second blade part by such a distance that the intersecting point between the counterholding force and the driving force lies outside the line of action of the cutting force of the blade part acting upon the workpiece to be cut. In this embodiment, the application surface acted upon with the driving force and the counterholding surface acted upon with the counterholding force are spaced apart farther than in the above-described embodiment, wherein the application surface and the counterholding surface are offset relative to one another—referred to a direction extending parallel to the mounting plane. For example, the offset between the counterholding surface and the application surface may correspond to one-third to two-thirds of the height of the blade part referred to the direction extending parallel to the mounting plane. The offset preferably amounts to one-tenth or more of an orthogonal distance between the mounting planes. The counterholding force of the cutting jaw, which essentially acts orthogonal to the mounting plane, may be applied, for example, on a projection or a step of the blade part in this region whereas the driving force of the cutting tool acts, for example, upon a distant lateral edge of the cutting tool. A surface normal of the lateral edge preferably is directed parallel to the mounting plane of the cutting jaw in this case.

According to another potential embodiment, which is of particular interest for cutting tools with a blade part that is immovably connected to an associated cutting jaw, the blade part may comprise a first partial region having the blade edge and a second partial region, which is connected to the cutting jaw and on which the first partial region is pivotably supported, wherein the intersecting point between the counterholding force of the cutting jaw and the driving force of the cutting tool defines a pivoting center, about which the first partial region can be pivoted relative to the second partial region and which lies outside the line of action of the cutting force of the blade part acting upon the workpiece to be cut. According to this embodiment, the blade part itself is composed of at least two parts, wherein a first and a second partial region are pivotably connected to one another such that the first partial region having the blade edge can be pivoted into the cutting plane. In this case, the connection between the first partial region and the second partial region may be produced, for example, by means of a screw that allows the pivoting movement of the first partial region relative to the second partial region. The screw or screws for fastening the first partial region on the second partial region are not firmly tightened in this case, but rather allow the aforementioned pivotability, wherein it may be preferred to bond the screws to the partial regions in order to limit the pivotability in a reproducible manner. According to this embodiment, the intersecting point between the counterholding force applied to the stationary second partial region and the driving force also lies outside the line of action of the cutting force of the blade part such that a torque is generated, wherein said torque pivots the pivotable first partial region about the pivoting center, the location of which preferably is identical to the intersecting point of the counterholding force and the driving force, such that the first partial region tilts in the direction of the cutting plane of the blade part.

The cutting tool may be designed in such a way that the cutting jaws are pivotably supported on a common axis of rotation. This design particularly is used in hand-operated cutting tools. At least one cutting jaw, but preferably both cutting jaws, can be pivoted about a common axis of rotation formed on the tool body in this case.

Alternatively, the cutting tool may be designed in such a way that at least one blade part is supported on the associated cutting jaw of the cutting tool in a linearly displaceable manner and the blade parts therefore can be displaced toward one another essentially parallel to the cutting plane. This design is particularly suitable for automatic cutting systems, but also for hand-operated cutting tools, in which the blade parts should be moved toward one another in the form of a linear movement.

The cutting jaws ultimately may be connected to the tool body in a separable manner. According to this embodiment, the cutting tool may be realized in the form of a universal tool that can accommodate different blade parts, but also other tool attachments, e.g., for bending, punching or crimping. Such an embodiment is also particularly advantageous in tools that carry out a large number of work processes and therefore require a frequent change of the tool attachment.

### BRIEF DESCRIPTION OF THE DRAWINGS

The invention is described in greater detail below with reference to exemplary embodiments. In the drawings:

FIG. 1 shows a cutting tool with a linearly displaceable blade part,

FIG. 2 shows a top view of the cutting tool according to FIG. 1,

FIG. 3 shows an enlarged partial region of the cutting tool in the form of a section along the line III-III in FIG. 2,

FIG. 3a shows an enlarged detail of the object according to FIG. 1 in the form of a section along the plane IIIa-IIIa,

FIG. 4 shows an arrangement of two blade parts according to the prior art with a workpiece to be cut,

FIG. 5 shows the arrangement according to FIG. 4 in the form of a longitudinal section,

FIG. 5a shows an exploded view of the arrangement after cutting the workpiece,

FIG. 6 shows a first inventive embodiment of two blade parts with a workpiece,

FIG. 7 shows a longitudinal section through the arrangement according to FIG. 6,

FIG. 8 shows a side view of the arrangement according to FIG. 6,

FIG. 9 shows another inventive embodiment of two cutting knives with a workpiece,

FIG. 10 shows a longitudinal section through the arrangement according to FIG. 9,

FIG. 11 shows a side view of the arrangement according to FIG. 9,

FIG. 12 shows another inventive embodiment of two cutting knives with a workpiece,

FIG. 13 shows a longitudinal section through the arrangement according to FIG. 12,

FIG. 13a shows an enlarged longitudinal section along the line XIIIa-XIIIa in FIG. 12,

FIG. 14 shows a side view of the arrangement according to FIG. 12,

FIG. 15 shows an inventive cutting tool according to an alternative embodiment with two cutting jaws that are pivotably supported on a common axis of rotation,

FIG. 16 shows a top view of the cutting tool according to FIGS. 15, and

FIG. 17 shows an enlarged partial region of the cutting tool according to

FIG. 15.

### DESCRIPTION OF THE EMBODIMENTS

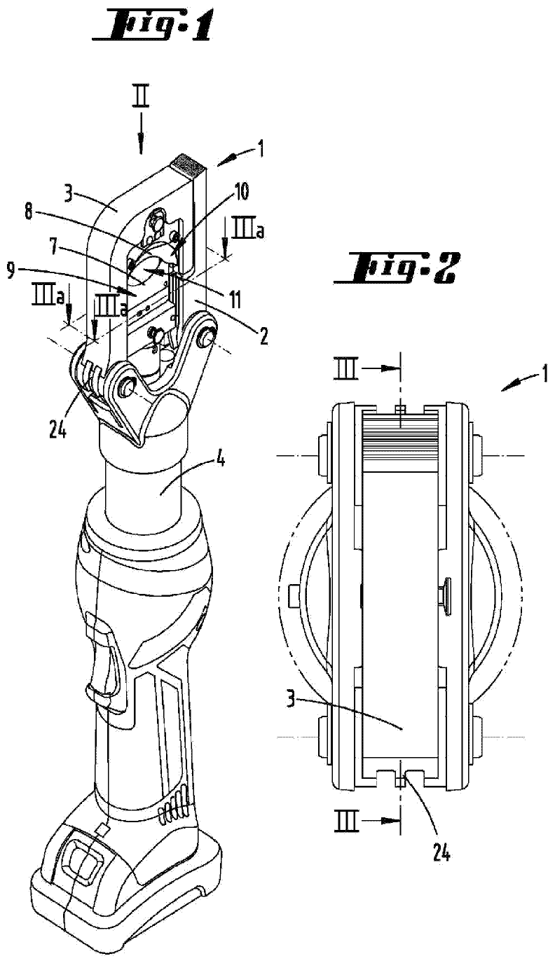

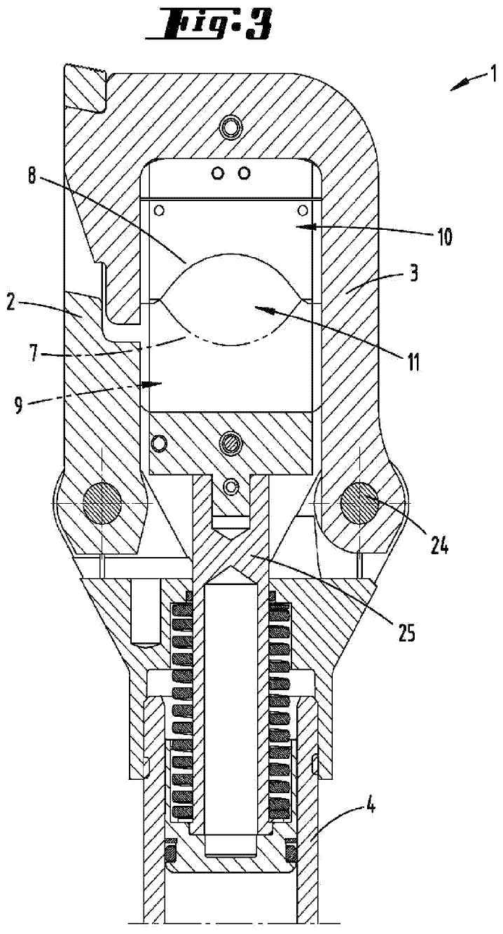

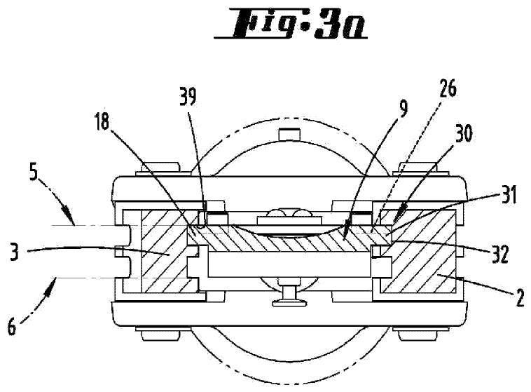

FIG. 1 shows an example of a potential embodiment of a cutting tool 1. In this case, the cutting tool 1 is realized in the form of a universal tool with exchangeable blade parts 9, 10. The blade parts 9, 10 are separably connected to cutting jaws 2, 3 of the cutting tool 1 and can be exchanged, for example, with other tool attachments for cutting, punching, crimping or the like. The cutting jaws 2, 3 are supported on a tool body 4 of the cutting tool 1, wherein at least one cutting jaw 2, 3 can be pivoted about a joint 24 in order to separate the two cutting jaws 2, 3 from one another and to remove the blade parts 9, 10. Details regarding the potential design of such a tool head can also be found in DE 199 26 481 A1 (U.S. Pat. No. 6,230,542 B1). Each blade part 9, 10 is designed with a blade edge 7, 8. The blade edges 7, 8 can be moved toward one another by upwardly displacing the blade edge 7 of the lower blade part 9 illustrated in the figure by means of a piston 25. This can be realized, for example, with the aid of a hydraulic force. The lower blade part 9 can be displaced relative to the tool body 4. In this case, the displacement essentially takes place in such a way that the blade edge 7 of the lower blade part 9 is displaced essentially parallel to and with the shortest possible distance from the blade edge 8 of the stationary blade part 10. A cutting plane 11 is formed between the blade edges 7, 8 that move toward one another. A workpiece 12 can be inserted into the cutting plane 11 of the cutting tool 1 (as illustrated, for example, in FIG. 4).

The blade parts 9, 10 are during a cutting process guided by means of a tongue and groove guide referred to the direction of displacement of the lower blade part 9. This is illustrated in FIG. 3a with reference to a plane of section through the lower blade part 9. The tongue and groove guide 30 is formed by a tongue 31 in the blade part 9 and a groove 32 in the cutting jaws 2, 3. This arrangement may also be reversed. This guide also forms the respective mounting planes 5 and 6 described below.

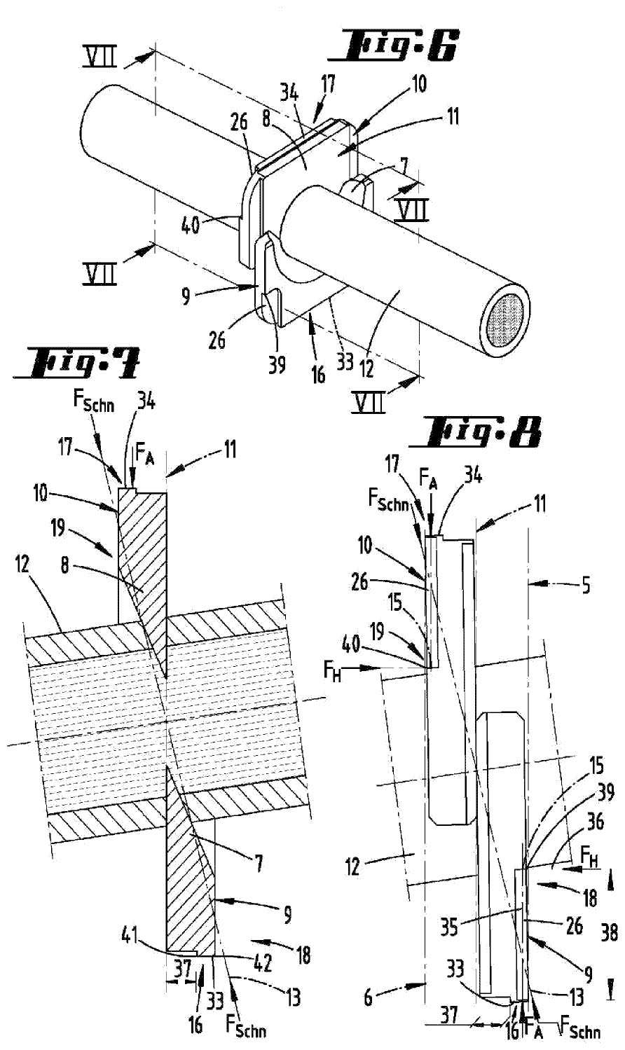

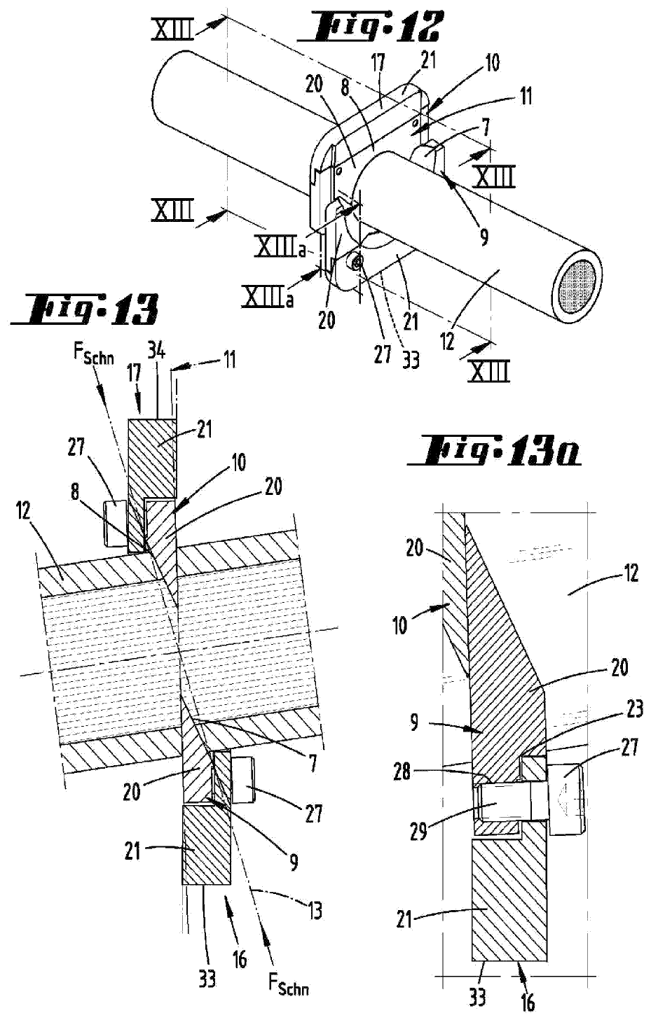

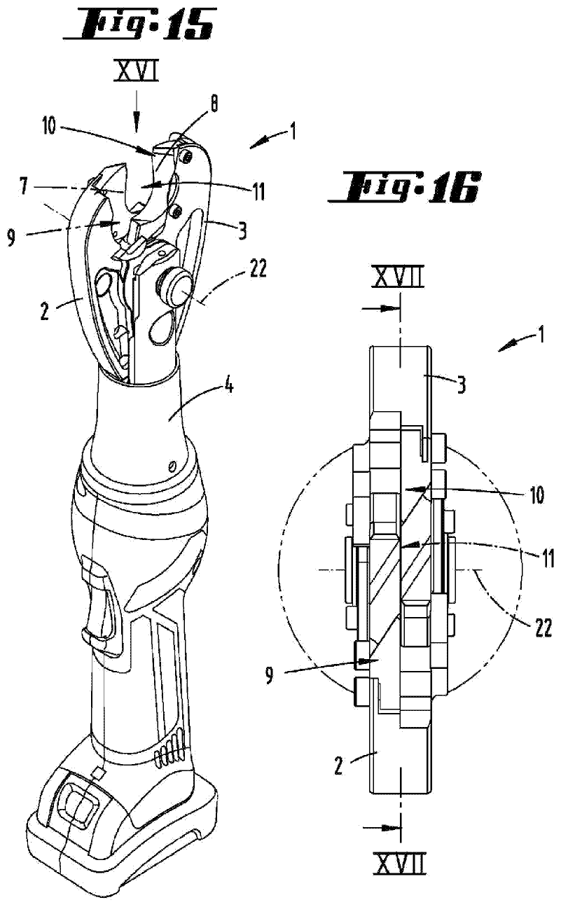

The blade parts 9, 10 are supported in the associated cutting jaw 2, 3 in such a way that a counterholding surface 39, 40 of the respective blade part 9, 10 is supported against a mounting contact region 18, 19 of the cutting jaw 2, 3, which is formed in a mounting plane 5, 6. In this case, a counterholding force F_{H}, which is described in greater detail below with reference to FIGS. 4 to 14, acts upon a side of the counterholding surface 39, 40 of the respective blade part 9, 10 facing away from the cutting plane 11. When the blade part 9, 10 pivots, i.e. tilts, relative to the mounting plane 5, 6, the counterholding surface 39, 40 is reduced to a contact line between the blade part 9, 10 and the mounting plane 5, 6 of the cutting jaw 2, 3.

FIGS. 4, 5 and 5a show an embodiment of a cutting tool 1 according to the prior art. These figures serve for elucidating the forces that act while a workpiece 12 is cut. FIG. 4 initially shows an arrangement with two blade parts 9, 10 of a cutting tool 1, the remaining components of which are not illustrated in this figure. A first blade part 9 has a first blade edge 7 whereas a second blade part 10 has a second blade edge 8. The two blade parts 9, 10 can be moved toward one another as illustrated in greater detail in FIG. 5. This is realized by either displacing the lower blade part 9 as described above with reference to the cutting tool 1 according to FIG. 1 or by displacing both blade parts 9, 10 in opposite directions. This is achieved, for example, by upwardly displacing a piston 25, which is illustrated in greater detail in FIG. 3, relative to the tool body 4. The piston 25 acts against an application surface 33 of an application region 16 of the blade part 9 with a driving force F_{A}. This driving force F_{A} causes a displacement of the lower blade part 9 parallel to the mounting plane 5 (or mounting plane 6), in which a partial region of the blade part 9, 10 respectively is held in a displaceable manner. The cutting jaw 2, 3 itself exerts a counterholding force F_{H} upon the counterholding surface 39, 40 of the blade part 9, 10 held on the cutting jaw, wherein the lines of force 35, 36 of the driving force F_{A} and the counterholding force F_{H} extend orthogonal to one another and intersect in an intersecting point 15. In this case, a resultant force corresponding to the driving force F_{A} forms a first line of force 35 whereas a resultant force corresponding to the counterholding force F_{H} forms a second line of force 36. The lines of force 35, 36 shown describe a resultant force that with respect to an amount and a line represent a computational and graphical summation of a force, which in reality acts two-dimensionally over the entire application surface 33, 34 or counterholding surface 39, 40, respectively. In this case, the lines of force 33, 34 and the counterholding surfaces 39, 40 are drawn at the locations, at which contact between the blade part 9, 10 and the mounting plane 5, 6 of the cutting jaw 2, 3 is also preserved upon pivoting or tilting of the blade part 9, 10. According to the prior art illustrated in FIG. 5, the intersecting point 15 of the lines of force 35, 36 lies, referred to the clockwise direction, behind the line of action 13 of the cutting force F_{Schn} exerted upon the workpiece 12 by the blade edges 7, 8. Consequently, the blade parts 9, 10 tilt outward, i.e. away from the cutting plane 11, while cutting finely stranded cables such that a cutting gap 14 between the blade edges 7, 8 is formed or increased. The line of action 13 of the cutting force F_{Schn} does not extend parallel to the cutting direction or cutting plane 11 of the cutting tool 1. The cutting force F_{Schn} acts via the corresponding reaction force in such a way that the blade parts 9, 10 are pressed apart from one another transverse to the cutting plane 11. Consequently, a cutting gap 14 is formed in the cutting plane 11 of the cutting tool 1. The blade parts 9, 10 accordingly have the tendency to be separated during such a cutting process. If the workpiece 12 consists, for example, of a finely stranded cable with a plurality of strands, individual strands may end up in this cutting gap 14 and become jammed therein such that the function of the cutting tool 1 is impaired. According to FIG. 5a, the design of the cutting gap 14 and therefore the spacing between the blade edges 7, 8 of the opposite blade parts 9, 10 furthermore lead to an incomplete cut such that the cutting plane of the workpiece 12 does not extend in an optimally planar manner, but rather has a feathering.

In order to avoid this problem, an inventive cutting tool 1 is proposed, in which the cutting gap 14 between the blade edges 7, 8 of the cutting tool 1 is prevented from forming or increasing.

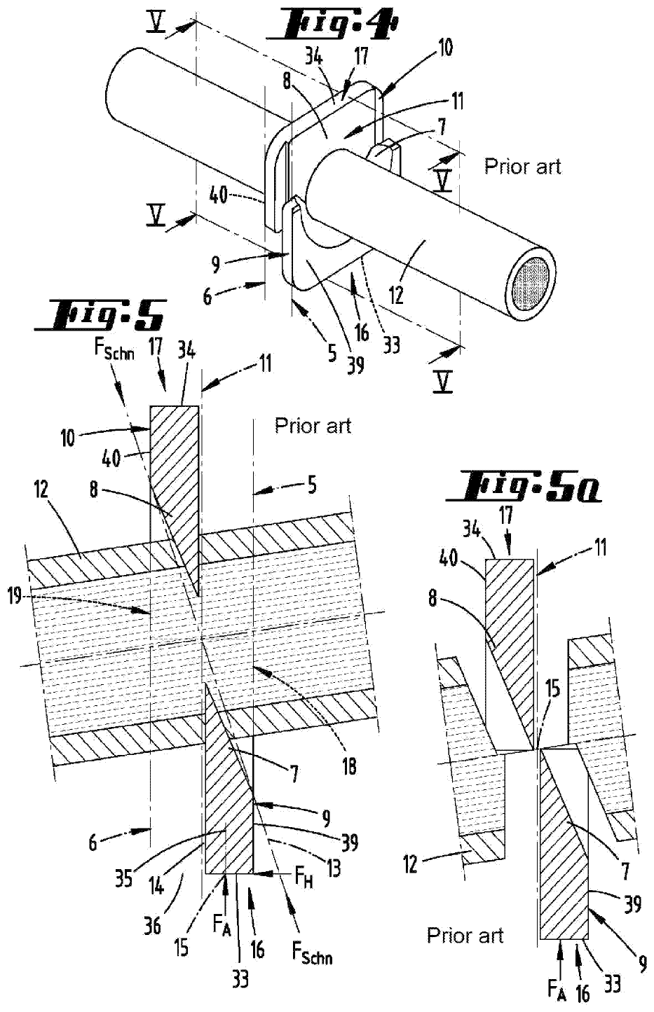

FIGS. 6 to 8 show a first embodiment, in which the blade parts 9, 10 are in comparison with the prior art modified in such a way that the intersecting point 15 of the driving force F_{A} applied to the corresponding blade part 9, 10 and the counterholding force F_{H} lies in front of the line of action 13 of the cutting force F_{Schn} referred to the clockwise direction, i.e. on the side of the line of action 13 illustrated in the figures, which faces away from the cutting plane 11. According to the embodiment illustrated in FIG. 6, the respective blade part 9, 10 has a material recess 26 in the mounting plane 5, 6 (see also the broken line of the material recess 26 illustrated in FIG. 3a). The piston 25 of the cutting tool 1 engages on the lower outer edge of the blade part forming the application surface 33. On the other hand, the respective blade part 9, 10 is held in the associated cutting jaw 2, 3 on the counterholding surface 39, 40 of the blade part 9, 10, which borders on the material recess 26 in a direction of displacement of the displaceable blade part 9. The force exerted on the counterholding surfaces 39, 40 therefore is, referred to the resultant, clearly shifted relative to the application surfaces 33, 34 for the displacement force (driving force F_{A}) in the direction of displacement. The application surfaces 33, 34, against which the driving force F_{A} acts, and the counterholding surfaces 39, 30, against which the counterholding force F_{H} acts, therefore are spaced apart from one another in such a way that the intersecting point 15 of these forces lies in front of the line of action 13 of the cutting force F_{Schn} referred to the respective blade part 9, 10. In this variation, the force application point of the counterholding force F_{H} is, referred to a direction extending parallel to the cutting plane 11, offset relative to the force application point of the driving force F_{A} in the direction of the respective opposite blade part 9, 10. Due to the material recess 26 of the cutting jaws 2, 3, the transmission of the lateral counterholding force F_{H} takes place on the higher outer edge of the material recess 26, i.e. the counterholding surface 39, 40. According to FIG. 8, the intersecting point 15 of the forces therefore lies in front of the line of action 13, in which the cutting force F_{Schn} of the cutting tool 1 acts, referred to the clockwise direction. Due to the resulting reaction force acting upon the blade edge 7, 8 during a cutting process, the respective blade part 9, 10 can tilt inward, i.e. in the direction of the cutting plane 11, in order to close a potentially formed cutting gap 14. A torque is generated due to the fact that the intersecting point 15 now lies farther outward, wherein said torque moves the blade parts 9, 10, which are held in the mounting plane 5, 6 in a minimally movable manner, toward one another, ideally in such a way that they just contact one another. In practical applications, the tilting movement of the blade parts 9, 10 amounts to less than 1°, preferably to one or several tenths of a degree.

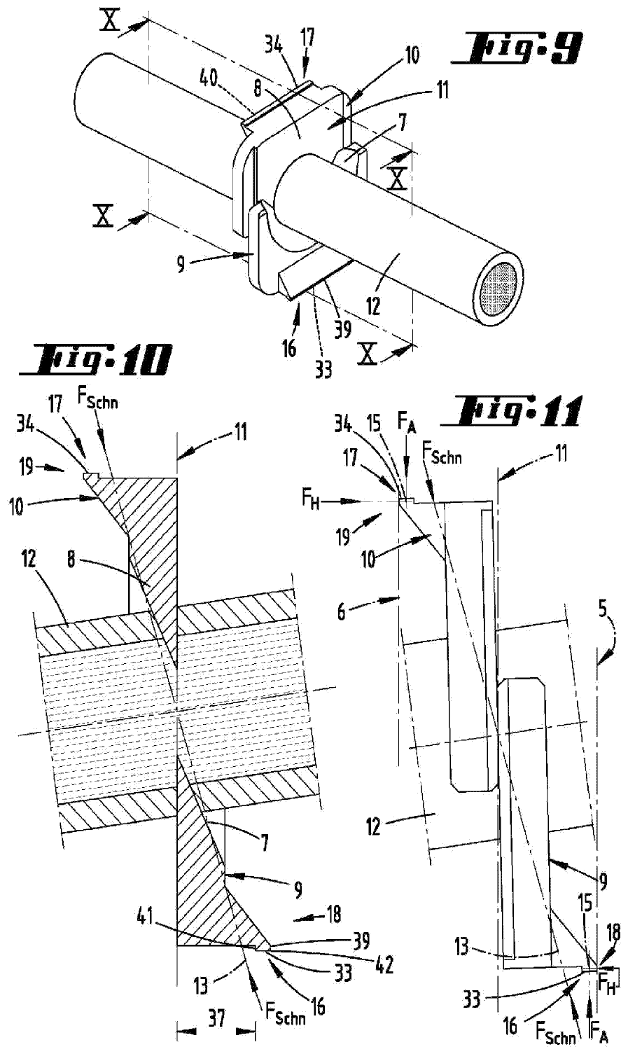

FIGS. 9 to 11 show another potential embodiment of an inventive cutting tool 1. In this embodiment, the blade parts 9, 10 are likewise designed in such a way that the intersecting point 15 of the driving force F_{A} and the counterholding force F_{H} lies in front of the line of action 13 of the cutting force F_{Schn} and a torque is generated, wherein said torque tilts the respective blade part 9, 10 in the direction of the cutting plane 11 such that the blade edges 7, 8 lie as close to one another as possible. For this purpose, the blade parts 9, 10 are shaped in such a way that the application surfaces 33, 34 of the application regions 16, 17 and the counterholding surfaces 39, 34 lie particularly far outward, i.e. at such a distance from the cutting plane 11 that the intersecting point 15 of the driving force F_{A} and the counterholding force F_{H} is located in front of the line of action 13 of the cutting force F_{Schn} referred to the clockwise direction. Since the application surfaces 33, 34 and the counterholding surfaces 39, 40 therefore are located relatively far from the cutting plane 11, this embodiment is particularly suitable for cutting tools 1 with relatively wide cutting jaws 2, 3. This is particularly unproblematic in industrial cutting systems that have sufficient structural space for respectively shifting the counterholding surfaces 39, 40 and the application surfaces 33, 34 outward beyond the line of action 13.

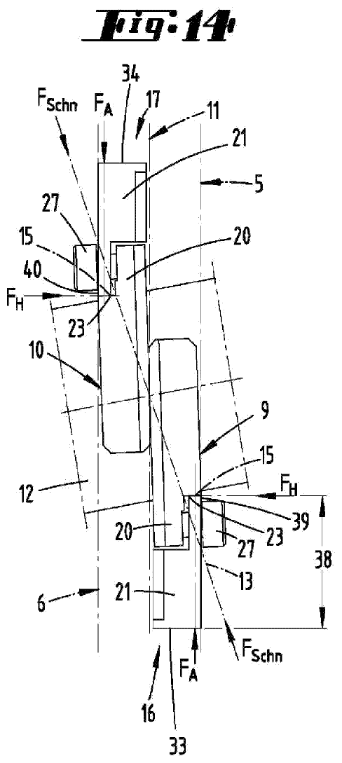

FIGS. 12 to 14 show another potential variation, in which the blade parts 9, 10 are composed of two parts, namely of a partial region 21 that is supported on the associated cutting jaw 2, 3 and a partial region 20 that is supported so as to be movable relative to the partial region 21. The two partial regions 20, 21 may be movably supported on one another with the aid of fastening means 27. In this example, the fastening means 27 are screws that may be additionally bonded in the threaded bore 28 of the partial region 20 accommodating the threaded shaft 29 of the fastening means 27 in order to permanently fix the adjusted freedom of movement (compare to FIG. 13a). Due to this freedom of movement, the movable partial region 20 can be tilted about a pivoting center 23 to such a degree that the blade edges 7, 8 of the corresponding blade parts 9, 10 can be guided on one another, namely while preventing the formation of a cutting gap 14. The driving force F_{A} and the counterholding force F_{H} are applied to the partial region 21 of the blade part 9, 10 that is stationary relative to the cutting jaw 2, 3, namely to an application surface 33, 34 and a counterholding surface 39, 40. The intersecting point 15 of the forces lies outside the line of action 13 of the cutting force F_{Schn}, namely in front of the line of action 13 referred to the clockwise direction. A thusly generated torque presses the partial region 20 of the blade part 9, 10 with the blade edge 7, 8 in the direction of the cutting plane 11. A defined pivoting center 23 therefore is formed in the intersecting point 15 of the directions of action of the driving force F_{A} and the counterholding force F_{H} due to the divided design of the blade parts 9, 10. The geometry of the blade parts 9, 10 is in this case also designed in such a way that the intersecting point 15 once again lies as far as possible outside the line of action 13 of the cutting force F_{Schn}. The advantages of this embodiment are the reliable function and the ability to use the thusly designed blade parts 9, 10 in different cutting tools 1. The weakening of the body of the blade part 9, 10 is not an issue, particularly in the relevant hand-operated cutting tools 1, because the workpieces 12 to be cut such as cables with fine strands only have a small material thickness. The cutting forces F_{Schn} to be applied for cutting these workpieces 12 are relatively low.

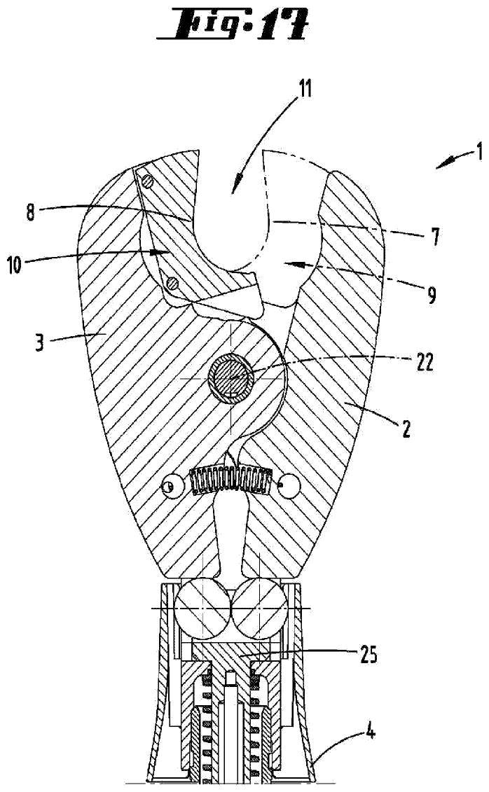

FIGS. 15 to 17 show another potential embodiment of a hand-operated cutting tool 1. In this embodiment, the cutting jaws 2, 3 of the cutting tool 1 are supported on a common axis of rotation 22. The cutting jaws 2, 3 and therefore also the blade parts 9, 10, which particularly are connected to said cutting jaws in an exchangeable manner, can be pivoted about this axis of rotation 22 essentially parallel to the cutting plane 11. In this embodiment, it is also possible to either move both cutting jaws 2, 3 toward one another or to move only one of the cutting jaws 2, 3 toward the other cutting jaw 2, 3 that is stationary relative to the tool body 4 of the cutting tool 1.

In the embodiment according to FIGS. 15 to 17, the blade parts 9, 10 are held on the cutting jaws 2, 3 in accordance with the above-described embodiment illustrated in FIGS. 12 to 14.

A cutting tool, which is characterized in that that the end 41 facing the cutting plane 11 defines the first distance 37 and that the first distance 37 and/or the second distance 38 are chosen in such a way that the intersecting point 15 lies in front of the line of action 13 of the cutting force F_{Schn} referred to a clockwise direction.

A cutting tool, which is characterized in that the end 41 facing the cutting plane 11 defines the first distance 37, in that the first distance 37 corresponds to one-tenth or more of an orthogonal distance between the mounting planes 5, 6 or the second distance 38 corresponds to one-tenth or more of an orthogonal distance between the mounting planes 5, 6 or the first distance 37, as well as the second distance 38, corresponds to one-tenth or more of an orthogonal distance between the mounting planes 5, 6, and in that the intersecting point 15 lies in front of a line of action 13 of a cutting force F_{Schn}, which acts upon the blade parts 9, 10 during a cutting process for cutting a workpiece 12, referred to a clockwise direction.

A cutting tool, which is characterized in that the blade edge 7, 8 is pivotable to such a degree that a cutting gap 14 formed between the blade parts 8, 10 while cutting the workpiece 12 is at least reduced, wherein the cutting gap 14 particularly is closed in that the first blade edge 7 of the first blade part 9 contacts the second blade edge 8 of the second blade part 10.

A cutting tool, which is characterized in that the blade part 9, 10 is pivotably supported on the associated cutting jaw 2, 3 or that a first partial region 20 of the blade part 9, 10 with a blade edge 7, 8 is pivotably supported on a second partial region 21 of the blade part 9, 10, which is immovably connected to the cutting jaw 2, 3, or that the cutting jaw 2, 3 carrying the blade part 9, 10 is pivotably supported on the tool body 4 of the cutting tool 1.

A cutting tool, which is characterized in that the blade part 9, 10 is designed in such a way that the counterholding surface 39, 40 of the blade part 9, 10, which is acted upon with the counterholding force, and the application surface 33, 34 of the blade part 9, 10, which is acted upon with the driving force F_{A}, are outwardly spaced apart from the cutting plane 11 by such a distance that their intersecting point 15 lies outside the line of action 13 of the cutting force F_{Schn} of the blade part 9, 10 acting upon the workpiece 12 to be cut.

A cutting tool, which is characterized in that the counterholding surface 39 of the first blade part 9, which is acted upon with the counterholding force F_{H}, is with respect to a direction extending parallel to the mounting plane 5 offset relative to the application surface 33 of the first blade part 9, which is acted upon with the driving force F_{A}, in the direction of the second blade part 10 by such a distance that the intersecting point between the counterholding force F_{H} and the driving force F_{A} lies outside the line of action 13 of the cutting force F_{Schn} of the blade part 9 acting upon the workpiece 12 to be cut.

A cutting tool, which is characterized in that the blade part 9, 10 comprises a first partial region 20 with the blade edge 7, 8 and a second partial region 21, which is connected to the cutting jaw 2, 3 and on which the first partial region 20 is pivotably supported, wherein the intersecting point 22 between the counterholding force F_{H} of the cutting jaw 2, 3 and the driving force F_{A} of the cutting tool 1 defines a pivoting center 23, about which the first partial region 20 can be pivoted relative to the second partial region 21 and which lies outside the line of action 13 of the cutting force F_{Schn} of the blade part 9, 10 acting upon the workpiece 12 to be cut.

A cutting tool, which is characterized in that the cutting jaws 2, 3 are pivotably supported on a common axis of rotation 24.

A cutting tool, which is characterized in that at least one blade part 9, 10 is supported on the associated cutting jaw 2, 3 of the cutting tool 1 in a linearly displaceable manner such that the blade parts 2, 3 can be displaced toward one another essentially parallel to the cutting plane 11.

A cutting tool, which is characterized in that the cutting jaws 2, 3 are separably connected to the tool body 4.

List of Reference Symbols

| | |
|---|---|
| 1 | Cutting tool |
| 2 | Cutting jaw |
| 3 | Cutting jaw |
| 4 | Tool body |
| 5 | Mounting plane |
| 6 | Mounting plane |
| 7 | Blade edge |
| 8 | Blade edge |
| 9 | Blade part |
| 10 | Blade part |
| 11 | Cutting plane |
| 12 | Workpiece |
| 13 | Line of action |
| 14 | Cutting gap |
| 15 | Intersecting point |
| 16 | Application region |
| 17 | Application region |
| 18 | Mounting contact region |
| 19 | Mounting contact region |
| 20 | Partial region |
| 21 | Partial region |
| 22 | Intersecting point |
| 23 | Pivoting center |
| 24 | Axis of rotation |
| 25 | Piston |
| 26 | Material recess |
| 27 | Fastening means |
| 28 | Threaded bore |
| 29 | Threaded shaft |
| 30 | Tongue and groove guide |
| 31 | Tongue |
| 32 | Groove |
| 33 | Application surface |
| 34 | Application surface |
| 35 | First line of force |
| 36 | Second line of force |
| 37 | First distance |
| 38 | Second distance |
| 39 | Counterholding surface |
| 40 | Counterholding surface |
| 41 | End |
| 42 | End |
| F_{Schn} | Cutting force |
| F_{A} | Driving force |
| F_{H} | Counterholding force |

1-10. (canceled)

11. A cutting tool comprising:
a tool body;
first and second cutting jaws on the tool body that can be displaced relative to one another, the first cutting jaw having a first mounting plane on which a first blade part with a first blade edge is supported, the second cutting jaw having a second mounting plane on which a second blade part with a second blade edge is supported, wherein a cutting plane, along which the first and second blade parts can be moved, generally lies parallel to the first and the second mounting plane planes, wherein the blade edge of the respective blade part or the respective blade part as a whole is pivotable transverse to the associated mounting plane, wherein the blade part has an application surface for a driving force, which generally extends orthogonal to the cutting plane, wherein mounting contact regions are formed in the mounting planes and a counterholding force acts upon a counterholding surface of the blade part or the blade edge, which is supported on the mounting plane, in said mounting contact regions on a side of the blade part or the blade edge facing away from the cutting plane, wherein a resultant force corresponding to the driving force furthermore forms a first line of force and a resultant force corresponding to the counterholding force forms a second line of force, wherein the first line of force and the second line of force intersect in an intersecting point in a cross-sectional plane, in which the cutting plane is provided in the form of a line, wherein the application surfaces are formed with a first distance orthogonal to the cutting plane and the counterholding surfaces are formed with a second distance from the respective application surface in the direction of the cutting plane, wherein a cutting force acting upon the blade parts during a cutting process furthermore causes a counterforce of a workpiece to be cut, wherein a line of action of the cutting force extends differently from a line of action of the counterforce, wherein each application surface has an end facing the cutting plane and an end facing away from the cutting plane, and wherein the ends of each application surface are located on the same side of the cutting plane, wherein the end facing the cutting plane defines the first distance and that the first distance and/or the second distance are provided such that that the intersecting point lies in front of the line of action of the cutting force referred to a clockwise direction.

12. The cutting tool according to claim 11, wherein the blade edge is pivotable to such a degree that a cutting gap formed between the blade parts while cutting the workpiece is at least reduced, wherein the cutting gap particularly is closed in that the first blade edge of the first blade part contacts the second blade edge of the second blade part.

13. The cutting tool according to claim 11, wherein the blade part is pivotably supported on the assigned cutting jaw or that a first partial region of the blade part with a blade edge is pivotably supported on a second partial region of the blade part, which is immovably connected to the cutting jaw, or that the cutting jaw carrying the blade part is pivotably supported on the tool body of the cutting tool.

14. The cutting tool according to claim 11, wherein the counterholding surface of the blade part, which is acted upon with the counterholding force, and the application surface of the blade part, which is acted upon with the driving force, are outwardly spaced apart from the cutting plane by such a distance that their intersecting point lies outside the line of action of the cutting force of the blade part acting upon the workpiece to be cut.

15. The cutting tool according to claim 11, wherein the counterholding surface of the first blade part, which is acted upon with the counterholding force, is with respect to a direction extending parallel to the mounting plane offset relative to the application surface of the first blade part, which is acted upon with the driving force, in the direction of the second blade part by such a distance that the intersecting point between the counterholding force and the driving force lies outside the line of action of the cutting force of the blade part acting upon the workpiece to be cut.

16. The cutting tool according to claim 11, wherein the blade part comprises a first partial region with the blade edge and a second partial region, which is connected to the cutting jaw and on which the first partial region is pivotably supported, wherein the intersecting point between the counterholding force of the cutting jaw and the driving force of the cutting tool defines a pivoting center, about which the first partial region can be pivoted relative to the second partial region and which lies outside the line of action of the cutting force of the blade part acting upon the workpiece to be cut.

17. The cutting tool according to claim 11, wherein the cutting jaws are pivotably supported on a common axis of rotation.

18. The cutting tool according to claim 11, wherein hat at least one blade part is supported on the associated cutting jaw of the cutting tool in a linearly displaceable manner such that the blade parts can be displaced toward one another generally parallel to the cutting plane.

19. The cutting tool according to claim 11, wherein the cutting jaws are separably connected to the tool body.

20. A cutting tool comprising:
a tool body;
first and second cutting jaws that can be displaced relative to one another, the first cutting jaw having a first mounting plane on which a first blade part with a first blade edge is supported, the second cutting jaw having a second mounting plane on which a second blade part with a second blade edge is supported, wherein a cutting plane, along which the blade parts can be moved, generally lies parallel to the first and the second mounting plane, wherein the blade edge of the respective blade part or the respective blade part as a whole is pivotable transverse to the associated mounting plane, wherein the blade part has an application surface for a driving force (F_{A}), which generally extends orthogonal to the cutting plane, wherein mounting contact regions are formed in the mounting planes and a counterholding force (F_{H}) acts upon a counterholding surface of the blade part or the blade edge, which is supported on the mounting plane, in said mounting contact regions on a side of the blade part or the blade edge facing away from the cutting plane, wherein a resultant force corresponding to the driving force (F_{A}) furthermore forms a first line of force and a resultant force corresponding to the counterholding force (F_{H}) forms a second line of force, wherein the first line of force and the second line of force intersect in an intersecting point in a cross-sectional plane, in which the cutting plane is illustrated in the form of a line, wherein the application surfaces are formed with a first distance orthogonal to the cutting plane and the counterholding surfaces are formed with a second distance from the respective application surface in the direction of the cutting plane, wherein a cutting force acting upon the blade parts during a cutting process furthermore causes a counterforce of a workpiece to be cut, wherein a line of action of the cutting force extends differently from a line of action of the counterforce, wherein each application surface has an end facing the cutting plane and an end facing away from the cutting plane, and wherein the ends of each application surface are located on the same side of the cutting plane, characterized in that the end facing the cutting plane defines the first distance, that the first distance corresponds to one-tenth or more of an orthogonal distance between the mounting planes or the second distance corresponds to one-tenth or more of an orthogonal distance between the mounting planes or the first distance, as well as the second distance, corresponds to one-tenth or more of an orthogonal distance between the mounting planes, and that the intersecting point lies in front of a line of action of a cutting force, which acts upon the blade parts during a cutting process for cutting a workpiece, referred to a clockwise direction.

21. The cutting tool according to claim 20, wherein the blade edge is pivotable to such a degree that a cutting gap formed between the blade parts while cutting the workpiece is at least reduced, wherein the cutting gap particularly is closed in that the first blade edge of the first blade part contacts the second blade edge of the second blade part.

22. The cutting tool according to claim 20, wherein the blade part is pivotably supported on the assigned cutting jaw or that a first partial region of the blade part with a blade edge is pivotably supported on a second partial region of the blade part, which is immovably connected to the cutting jaw, or that the cutting jaw carrying the blade part is pivotably supported on the tool body of the cutting tool.

23. The cutting tool according to claim 20, wherein the counterholding surface of the blade part, which is acted upon with the counterholding force, and the application surface of the blade part, which is acted upon with the driving force, are outwardly spaced apart from the cutting plane by such a distance that their intersecting point lies outside the line of action of the cutting force of the blade part acting upon the workpiece to be cut.

24. The cutting tool according to claim 20, wherein the counterholding surface of the first blade part, which is acted upon with the counterholding force, is with respect to a direction extending parallel to the mounting plane offset relative to the application surface of the first blade part, which is acted upon with the driving force, in the direction of the second blade part by such a distance that the intersecting point between the counterholding force and the driving force lies outside the line of action of the cutting force of the blade part acting upon the workpiece to be cut.

25. The cutting tool according to claim 20, wherein the blade part comprises a first partial region with the blade edge and a second partial region, which is connected to the cutting jaw and on which the first partial region is pivotably supported, wherein the intersecting point between the counterholding force of the cutting jaw and the driving force of the cutting tool defines a pivoting center, about which the first partial region can be pivoted relative to the second partial region and which lies outside the line of action of the cutting force of the blade part acting upon the workpiece to be cut.

26. The cutting tool according to claim 20, wherein the cutting jaws are pivotably supported on a common axis of rotation.

27. The cutting tool according to claim 20, wherein hat at least one blade part is supported on the associated cutting jaw of the cutting tool in a linearly displaceable manner such that the blade parts can be displaced toward one another generally parallel to the cutting plane.

28. The cutting tool according to claim 20, wherein the cutting jaws are separably connected to the tool body.
